(19) United States
(12) Patent Application Publication
(10) Pub. No.: US 2008/0091337 A1
(43) Pub. Date: Apr. 17, 2008

(54) METHOD FOR TRANSMITTING AND RECEIVING TRAFFIC INFORMATION AND APPARATUS FOR RECEIVING TRAFFIC INFORMATION

(75) Inventor: Ho Taek HONG, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/859,230

(22) Filed: Sep. 21, 2007

Related U.S. Application Data
(60) Provisional application No. 60/829,177, filed on Oct. 12, 2006.

(30) Foreign Application Priority Data
Nov. 3, 2006 (KR) 10-2006-0108218

(51) Int. Cl. G06F 19/00

(52) U.S. Cl. 701/117

(57) ABSTRACT

A method for transmitting and receiving traffic information and an apparatus for receiving traffic information are provided. The method for transmitting traffic information encodes and transmits a traffic information message including an identifier of at least one of a plurality of location reference methods for representing location information used to provide traffic information. The method for receiving traffic information first receives a signal including a traffic information message and demodulates the received signal to obtain a traffic information message and decodes the traffic information message. Then, the method obtains, from the traffic information message, an identifier of at least one of a plurality of location reference methods for representing location information used to provide traffic information. The method then provides traffic information according to location information based on the location reference method.

This application claims the benefit of the Korean Patent Application No. 10-2006-0108218, filed on Nov. 3, 2006, which is hereby incorporated by reference as if fully set forth herein. Also, this application claims the benefit of U.S. Provisional Application No. 60/829,177, filed on Oct. 12, 2006, which is hereby incorporated by reference.

### BACKGROUND OF THE INVENTION

1. Field of the Invention

The present invention relates to a method for transmitting and receiving traffic information and an apparatus for receiving traffic information.

2. Discussion of the Related Art

Radio and TV broadcasting has evolved from analog to digital along with development and integration of digital signal processing and communication technologies. Data broadcasting which broadcasts program information or daily life information has also been developed along with the digital broadcasting. An increase in the number of cars in cities due to the spread of private cars and an increase in the number of cars in areas outside cities due to an increase in the number of holidays have increased the need to provide traffic information of roads. While broadcasts carrying traffic information are provided by the radio to meet the need, they are provided only at specified times. Thus, there is a need to transmit traffic information in real time.

The traffic information is location-based information. A number of location reference methods are used to transmit and receive such location-based information. It is difficult to provide universal location information with a specific location reference method since there are various types of location reference methods and many countries use different national standards.

### SUMMARY OF THE INVENTION

Thus, there is a need to previously indicate or provide information of a specific method that has been used to provide location information when the location information can be provided according to various methods.

To meet this need, the present invention is directed to a method for transmitting and receiving traffic information and an apparatus for receiving traffic information that substantially obviate one or more problems due to limitations and disadvantages of the related art.

An object of the present invention is to provide a method for transmitting traffic information including information for identification of a location reference method applied to location information.

Another object of the present invention is to provide a method and apparatus for receiving traffic information including information for identification of a location reference method applied to location information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for transmitting and receiving traffic information and an apparatus for receiving traffic information are provided. The method for transmitting traffic information encodes and transmits a traffic information message including an identifier of at least one of a plurality of location reference methods for representing location information used to provide traffic information. The method for receiving traffic information first receives a signal including a traffic information message and demodulates the received signal to obtain a traffic information message and decodes the traffic information message. Then, the method obtains, from the traffic information message, an identifier of at least one of a plurality of location reference methods for representing location information used to provide traffic information. The method then provides traffic information according to location information based on the location reference method.

The method for transmitting traffic information includes encoding a traffic information message including an identifier of at least one of a plurality of location reference methods for representing location information used to provide traffic information and transmitting the encoded traffic information message.

In another aspect, the method for receiving traffic information includes receiving a signal including a traffic information message, demodulating the received signal to obtain a traffic information message and decoding the traffic information message, obtaining, from the traffic information message, an identifier of at least one of a plurality of location reference methods for representing location information used to provide traffic information and providing traffic information according to location information based on the location reference method.

In another aspect, the apparatus for receiving traffic information includes a wireless communication unit, a demodulator, a decoder, a storage unit, a GPS module, a controller, a display driver, and a display. The wireless communication unit receives a signal including a traffic information message. The demodulator demodulates a signal output by the wireless communication unit. The decoder decodes a traffic information message from a signal output by the demodulator. The storage unit stores geographical information according to location information that can be used to present traffic information. The GPS module outputs current location information. The controller obtains an identifier of at least one location reference method output by the decoder and performs a control operation to present traffic information of the traffic information message according to location information of a location reference method corresponding to the identifier using both the geographical information stored in the storage unit and the current location information output by the GPS module. The display driver outputs a drive signal to present a graphic signal according to control of the controller. The display presents traffic information according to the drive signal from the driver.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 schematically shows a digital multimedia broadcast system that provides traffic information;

FIG. 2 shows a format of wirelessly communicated traffic information;

FIG. 3 shows the structure of a Transport Protocol Expert Group (TPEG)—location container;

FIG. 4 shows an example representing the type of location information and the position of an identifier (ID);

FIG. 5 shows another example representing the type of location information and the position of an ID;

FIG. 6 shows location information written in service guide information of a traffic information message;

FIG. 7 shows an example of identification information illustrated in FIG. 6;

FIG. 8 shows an example of a message management container of a traffic information message;

FIGS. 9 to 11 show an example of inclusion of location information according to a location reference method ID in a Road Traffic Message (RTM) component;

FIG. 12 shows an example of the location reference method ID of FIGS. 9 to 11;

FIG. 13 shows an embodiment of a terminal for receiving traffic information;

FIG. 14 is a flow chart showing an embodiment of a method for receiving traffic information; and

FIG. 15 is a flow chart showing an example of a method for obtaining location information included in the method for receiving traffic information.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In the following description of the present invention, a detailed description of known functions and configurations incorporated herein will be omitted when it may obscure the subject matter of the present invention.

Traffic information used in the present implementation can be applied to a variety of digital broadcast standards. Examples of the digital broadcast standards include European Digital Audio Broadcasting (DAB) based on Eureka-147 (ETSI EN 300 401), Digital Video Broadcasting-Terrestrial (DVB-T), Digital Video Broadcasting-Handheld (DVB-H), American Media Forward Link only (MediaFLO), and Korean Digital Multimedia Broadcasting (DMB). The Korean DMB is classified into Terrestrial-DMB (T-DMB) based on Eureka-147 and Satellite-DMB (S-DMB) using satellite communication.

The term “traffic information” used in the following description refers to information regarding public transportation, congestion and travel time, road traffic, emergencies, and the like. In the case where a method of providing such traffic information complies with the Transport Protocol Expert Group (TPEG) standard, a term “TPEG” will be used to indicate it for ease of explanation. The traffic information is dependent on location and each message includes information regarding location.

The term “location reference method or type” used in the following description refers to a method or type of constructing location information used for traffic information that is location-based information. In the following description, TPEG-LOC, Agora-C, pre-coded Korean node-link ID, and VICS link methods will be used as examples of the location reference method. “VICS” means information which is Advanced Travel Information System in Japan. Also Agora-C and pre-coded Korean node-link ID are referred as examples regarding location information in order to represent traffic information.

The term “application service information” used in the following description refers to information included in a container which provides information associated with a variety of services in a message structure that provides a specific service in TPEG technologies. In the following description, Congestion and Travel Time (CTT) information, a Road Traffic Message (RTM), and Public Transport Information (PTI) will be used as examples of the application service information.

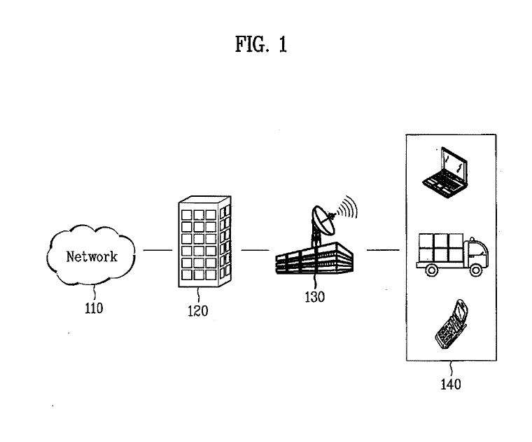

Terms other than those described above may also be used if they indicate the same functions. FIG. 1 schematically shows a digital multimedia broadcast system that provides traffic information. A method for providing traffic information through a wireless signal will now be described with reference to FIG. 1.

The digital multimedia broadcast system includes a network 110 through which traffic information-related content is collected, a traffic information server 120 that provides collected content, a broadcast center 130, and a terminal 140. The traffic information server 120 in a broadcaster reconstructs various traffic information, for example input by the operator or collected from other servers through the network 110, and transmits the traffic information through a transmitter in the broadcast center 130 so that it can be received by a receiver provided in any of a variety of terminals, for example a mobile phone, a vehicle, a Personal Digital Assistant (PDA), or any other portable terminal. The terminal 140 may also include, but not is limited to, a navigator or a computer such as a notebook computer. The traffic information server 120 can use not only a digital broadcast data channel as a path to transmit traffic information but also the wired/wireless Internet, for example, a broadband wireless medium such as the Wi-Fi or Wireless Broadband Internet (Wibro) or the Internet using wired cables. Especially, a Multimedia Object Transport (MOT) protocol or a Transparent Data Channel (TDC) protocol for digital broadcast media may be used in the case where a Digital Multimedia Broadcasting (DMB) data service is used to transmit traffic information.

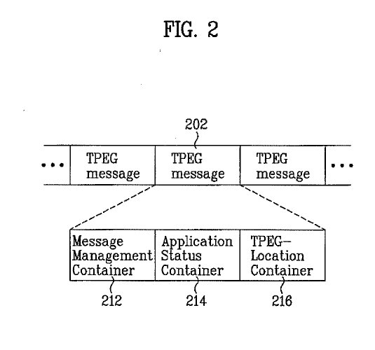

FIG. 2 shows a format of wirelessly communicated traffic information.

As illustrated in FIG. 2, a traffic information message structure includes a message management container 212, an application event (status) container 214, and a TPEG-location container 216.

Information used for traffic information message management such as version information, message identification information, or date and time information is created and included in the message management container 212. The application event (status) container 214 includes different information for each service and information of each service is constructed in a different format.

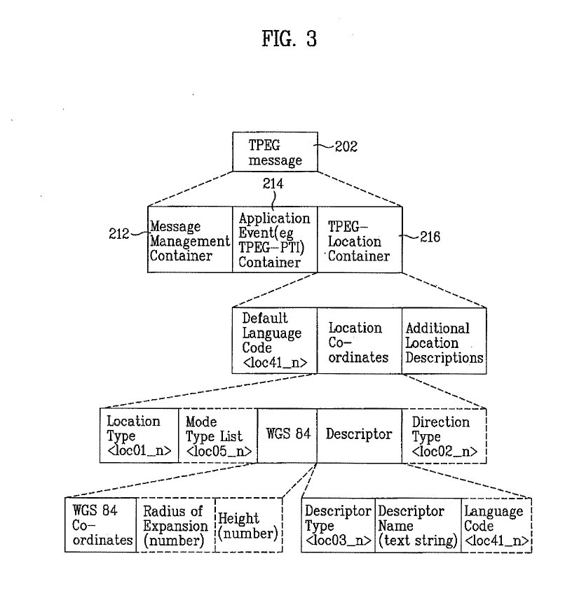

The TPEG-location container 216 includes information regarding location associated with a corresponding service. Particularly, the TPEG-location container 216 provides location information used to provide traffic information to a receiving end according to its structure illustrated in FIG. 3.

However, each country uses a different standard to provide location information. For example, Europe uses an Agora-C location reference type (or method), Korea uses a Pre-coded Korean Node-Link ID type which has been defined as a location information standard, and Japan uses a VICS link type.

In the case where location information is provided using the container as illustrated in FIG. 3, it is difficult to provide location information of various location reference types although it is possible to provide location information of the single type. In addition, if location information is provided using the structure illustrated in FIG. 3, data may be carried in unnecessary fields depending on the standard. Thus, a method for providing location information using standards of various location reference types will be disclosed in the following description.

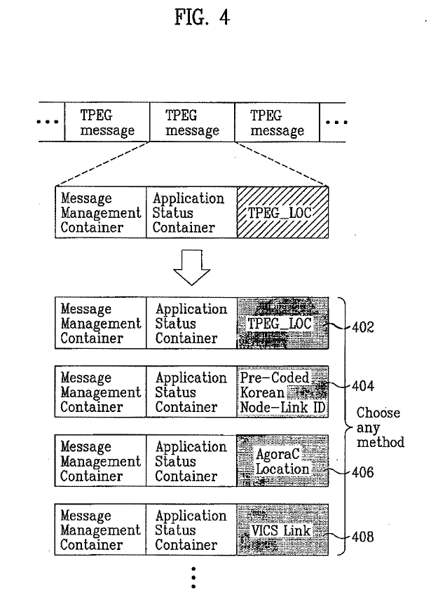

One example is to change the TPEG location container to location information defined for a different standard. As illustrated in FIG. 4, without changing structures of a TPEG message which constitute a data stream of the TPEG message, its TPEG location container may be changed to location information that is configured using location information according to the variety of location reference types (or methods). For example, a TPEG location container 402 can be changed to a Pre-coded Korean Node-Link ID location reference type 404 that is mainly used in Korea. The TPEG location container 402 can also be changed to an Agora-C location reference type 406 that is mainly used in Europe. The TPEG location container 402 can also be changed to a VICS link location reference type 408 that is mainly used in Japan. In this case, different language can be applied to provide location information according to the changed location reference type.

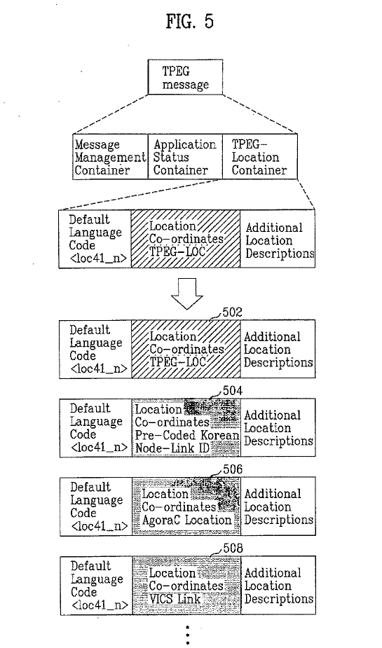

Another example is to change location coordinates included in a TPEG location container to location information according to the variety of location reference types. As illustrated in FIG. 5, without changing the structure of a TPEG location container, location coordinates included in the container may be changed to location information that is configured using a standard used in each country. For example, location coordinates 502 can be changed to a Pre-coded Korean Node-Link ID location reference type 504 that is mainly used in Korea. The location coordinates 502 can also be changed to an Agora-C location reference type 506 that is mainly used in Europe. The location coordinates 502 can also be changed to a VICS link location reference type 508 that is mainly used in Japan. In this case, different language can be applied according to the changed location reference type.

Here, each of the Pre-coded Korean Node-Link ID location reference type and the VICS link location reference type is a pre-coded type and the Agora-C location reference type is a dynamic type. The pre-coded type is based on a method using a master database (DB) in which the terminal system analyzes location information using a mediation DB such as a mapping table between a DB of the terminal system and the master DB. The dynamic type uses a method in which a transmitting end transmits location information by encoding it according to a specified coding scheme and a receiving end receives and decodes the encoded information to analyze the location of its map.

In the case where location information has been encoded according to the variety of location reference types (or methods) as described above, there may be a variety of corresponding methods to analyze the location information.

In the case where location information has been transmitted according to a variety of location reference types, a receiving end that receives traffic information can appropriately decode location information only when it knows which standard has been used to construct the location information. Thus, the examples herewith provides a method for distinguishing between location information constructed using a variety of methods.

In a first embodiment, information for identification of the location reference method (or type) of location information used in overall services can be provided by incorporating it in TPEG Service and Network Information (TPEG-SNI) which includes service network information containing overall service guide information of TPEG services.

In a second embodiment, the information for identification of the location reference method of location information can be provided using a field in a message management container that includes message management information used to manage TPEG messages.

In a third embodiment, the information for identification of the location reference method of location information can be provided using a field at the header of a location container including location information.

These embodiments will now be described in detail with reference to the drawings.

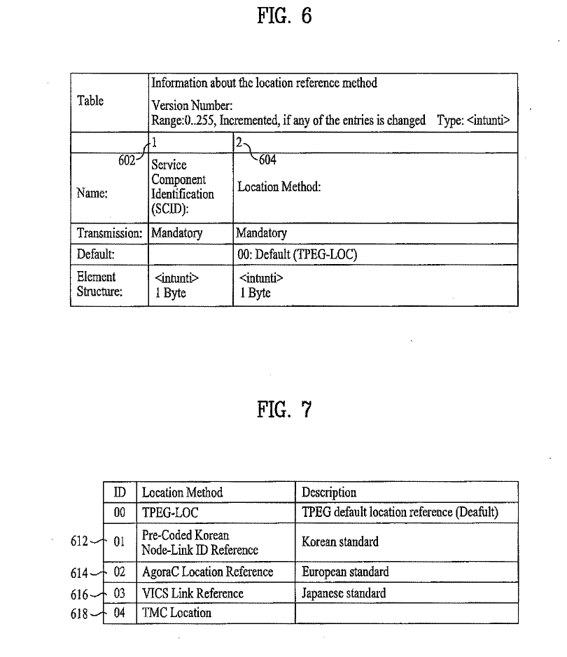

FIG. 6 shows a service guide table according to the first embodiment. FIG. 7 shows a table describing ID information of location information among a variety of information shown in FIG. 6. The first embodiment will now be described with reference to FIGS. 6 and 7.

To analyze a number of TPEG messages transmitted in the form of a data stream, first, TPEG Service and Network Information (TPEG-SNI) is analyzed. The TPEG-SNI carries information regarding a communication network and a variety of services communicated according to the TPEG method. According to information (or content) transmitted in the TPEG-SIN, it is possible to analyze and use all other services included in the TPEG message. Generally, the TPEG-SNI includes high-speed tuning information for analysis of a variety of services such as Service Component Identification (SCID), Contents Identification (COID), and Application Identification (AID). The TPEG-SNI also includes a table of time schedule information, content details information, broadcast region information, initialization-related information, reception restriction and authentication information, component connection information, and the like.

For example, using the SCID, the terminal can identify whether a component transmitted is Congestion and Travel Time (CTT) information, a Road Traffic Message (RTM), or Public Transport Information (PTI). In this case, the TPEG-SNI includes information regarding which component each SCID indicates in a TPEG message.

In this case, in the TPEG-SNI according to the first embodiment, the information for identification of the location reference method of location information can be transmitted after being coded into a value as illustrated in FIG. 7.

In FIG. 6, a Service Component Identification (SCID) field 602 is used to distinguish between a number of service components transmitted within a data frame. The location method field 604 includes information for identification of the location reference method of location information. It is possible to describe various location reference methods of location information by setting such identification information in the location method field 604.

An example of the information that can be included in the location method field 604 is shown in FIG. 7. For example, when the location method field 604 is “00”, it can represent a location method (TPEG-LOC) defined in the TPEG.

For example, an ID value “01” 612 can represent “Pre-coded Korean Node-Link ID reference”, which is a standard used in Korea, an ID value “02” 614 can represent “Agora-C location reference” which is a standard used in Europe, and an ID value “03” 616 can represent “VICS link reference” which is a standard used in Japan. In addition, an ID value “04” 618 can represent “traffic message channel (TMC) location reference”.

If the location reference specification method uses TPEG-SNI as described above, it is possible to specify a location reference method without changing the structure of the TPEG message.

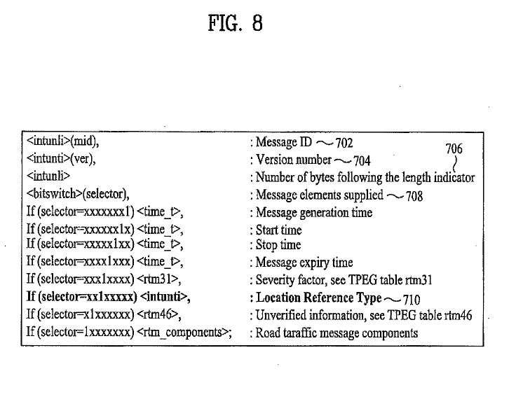

FIG. 8 illustrates a message management container of a TPEG message according to the second embodiment. The second embodiment will now be described in detail with reference to FIG. 8.

Message management information included in a message management container includes information items used to manage each TPEG message. As illustrated in FIG. 8, the message management information may include fields such as a message identifier (ID) 702, a version number 704, a data length indicator 706, and a selector 708.

The message ID 702 is identification information used to distinguish between TPEG messages, the version number 704 is version information required to keep each message updated, and the length indicator 706 provides a total message length to indicate a valid area of data. The selector 708 is used to carry information required for each message in a variable manner. Up to 8 fields may be added according to bits set to “1” in the selector 708. For example, a message generation time, a start time, a stop time, a message expiry time, etc., are added. Different fields may be added according to the type of each TPEG message.

The message management information described above is used to manage information received by a decoder. The message management information according to the embodiment of the present invention may include identification information indicating the location reference method of location information. For example, information regarding a location reference type may be set in a field 710 whose selector value of the message management information is “xx1xxxx”. The values illustrated in FIG. 7 may be used as ID values indicating the location reference types.

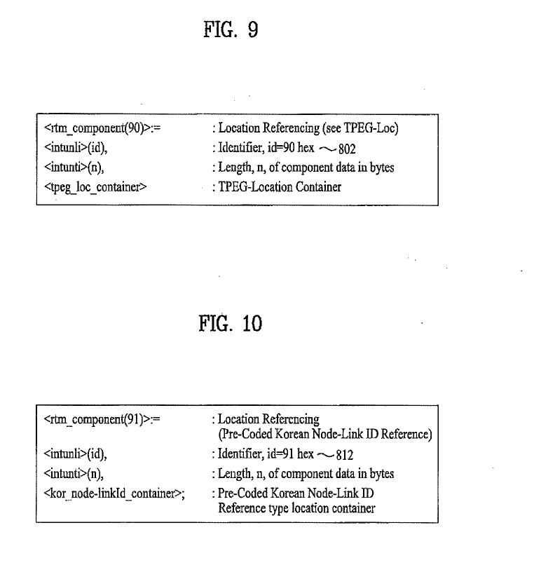

FIGS. 9 to 12 show examples of location reference type information of location information set in a component of a TPEG message according to the third embodiment. Location information may be included in one of the components of a TPEG message. In the examples of FIGS. 9 to 11, location information is included in a Road Traffic Message (RTM) component.

A component ID 802 indicating a location container including location information for the RTM component is “90 hex” as illustrated in FIG. 9. Each component ID has a value specified to identify a corresponding component. This value can be used to represent location reference type information.

For example, when the component ID is set to “90” (802) as illustrated in FIG. 9, a component corresponding to this component ID may include a length of the component which indicates location information and location information (TPEG-location container) which uses the TPEG-LOC that is a standard defined in the TPEG.

When the component ID is set to “91” (812) as illustrated in FIG. 10, it indicates location information (Pre-coded Korean Node-Link ID Reference type location container) according to the Pre-coded Korean Node-Link ID reference type which is a standard used in Korea.

When the component ID is set to “92” (822) as illustrated in FIG. 11, it indicates location information (Agora-C Location Reference Type Location Container) according to the Agora-C location reference type which is a standard used in Europe.

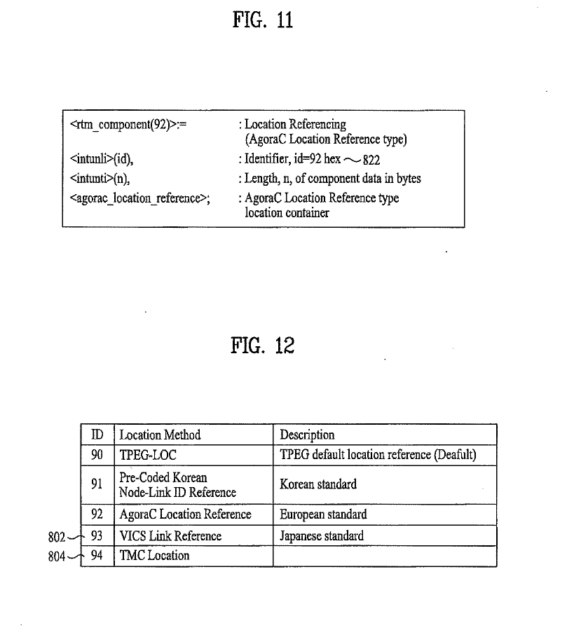

FIG. 12 shows a table illustrating an example where location information according to each location reference method is classified by the component ID. As described above, a component ID set to “90” indicates location information according to the TPEG-LOC, a component ID set to “91” indicates location information according to the Pre-coded Korean Node-Link ID reference type, and a component ID set to “92” indicates location information according to the Agora-C location reference type. In addition, a component ID set to “93” (832) indicates the VICS link reference type which is used in Japan and a component ID set to “94” (834) indicates the TMC location reference type. The component ID values illustrated in FIG. 12 can be applied when the application service is a Road Traffic Message (RTM) or a Congestion and Travel Time (CTT) information and different component ID values may be defined depending on the application service.

A traffic information message can be encoded by incorporating the ID of the location reference type indicating location information into the traffic information message in the above manner and the encoded traffic information message can then be transmitted and received through the communication system as illustrated in FIG. 1.

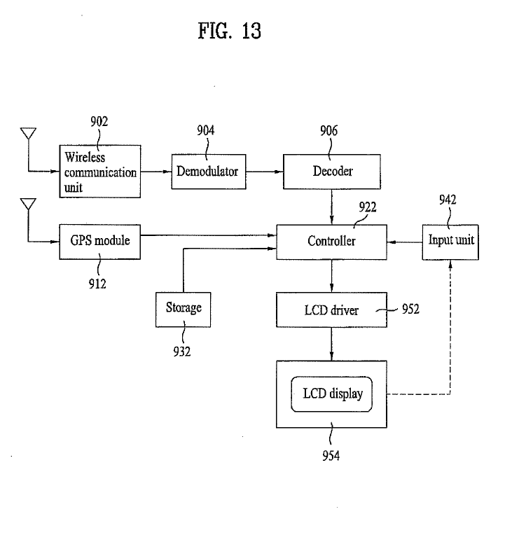

FIG. 13 is a block diagram showing an internal configuration of a terminal according to an embodiment which receives traffic information transmitted from the broadcast center 130.

As illustrated in FIG. 13, the terminal which uses received traffic information includes a wireless communication unit 902, a demodulator 904, a decoder 906, a global positioning system (GPS) module 912, a controller 922, an input unit 942, a liquid crystal display (LCD) driver 952, an LCD display 954, and a storage unit 932. The following is a detailed description of the function of each component of the terminal shown in FIG. 13.

A wireless communication module 902 outputs a modulated traffic information signal received by tuning to a signal band carrying traffic information to the demodulator 904. The demodulator 904 demodulates and outputs the modulated traffic information signal to the decoder 906. The decoder 906 decodes the demodulated traffic information signal and outputs a variety of traffic information. The GPS module 912 receives satellite signals transmitted from a plurality of low orbit satellites and calculates and outputs a current position (longitude, latitude, and height). The storage unit 932 stores a variety of graphic information and electronic maps including geographical information according to position information which are used to provide traffic information to each link, each node, and the like. The input unit 942 receives inputs from the user. The controller 922 controls output to the screen based on information received from the user through the input unit 942, current position information received through the GPS module 912, and traffic information received through the wireless communication unit 902. The LCD driver 952, which is a display driver, drives the LCD display 954 which is a screen display according to a drive signal output from the controller 922. The LCD display 954 receives a graphic signal from the LCD driver 952 and displays an image. The input unit 942 may be a touch screen provided on the LCD display 954 and may also be a keypad, a jog dial, or a point stick.

The wireless communicator 902 tunes to a signal transmitted by the traffic information server 120 and the demodulator 904 demodulates and outputs the tuned signal in a specified method. The decoder 906 receives the demodulated signal and decodes a traffic information message (for example, a TPEG message sequence) and then transmits traffic information and location information according to the contents of the decoded message to the controller 922.

According to the first embodiment illustrated above, the decoder 906 performs SCID value decoding to decode TPEG-SNI including service guide information whose SCID value is “00”. The decoder 906 decodes and outputs identification information indicating a location reference method in the TPEG-SNI to the controller 922. The controller 922 can control an application service (or application service information) included in the traffic information message to be output according to the location reference method received using the identification information output by the decoder 906.

According to the second embodiment, the decoder 906 can decode identification information of a location reference method that is included in a message management container of the traffic information message. Upon receiving the identification information of the location reference method decoded by the decoder 906, the controller 922 can control an application service such as CTT information to be output according to location information based on the decoded location reference method.

According to the third embodiment, the decoder 906 can decode location information of a location container in the TPEG message according to a location container ID including location information. The controller 922 can receive the location information included in the location container from the decoder 906 and can cause an application service to be presented according to the received location information.

The controller 922 can control the traffic information decoded by the decoder 906 to be presented using current position information of a traffic information receiver received from the GPS module 912 and geographical information and graphic information stored in the storage unit 932.

For example, if identification information of a location reference method is included in a message management container even when identification information of another location reference method is included in TPEG-SNI, the controller 922 can cause a traffic information service to be provided using only the location reference method according to the identification information included in the message management information.

Similarly, if identification information (component ID) of a location reference method is included in a location container even when identification information of another location reference method is included in TPEG-SNI, the controller 922 can cause a traffic information service to be provided using the location reference method indicated by the identification information included in the message management information.

If IDs which can identify different location reference methods are included in TPEG-SNI, a message management container, and a location container, the controller 922 can analyze location information using a location reference method indicated by the ID included in the location container. For example, in some case, an ID included in a location container may indicate a Pre-coded Korean Node-Link ID reference method while an ID included in TPEG-SNI indicates a VICS link reference method and an ID included in a message management container indicates an Agora-C location reference method. In this case, the controller 922 can cause a traffic information service to be provided using location information corresponding to a Pre-coded Korean Node-Link ID according to the location reference method of the location container.

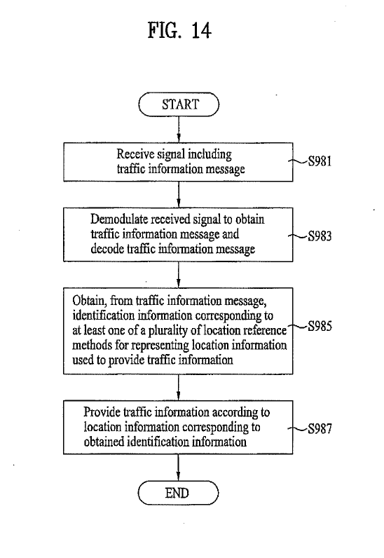

FIG. 14 is a flow chart showing a method for receiving traffic information using identification information according to an embodiment of the present invention.

First, a signal including a traffic information message is received in order to receive and present traffic information (S981).

The received signal is demodulated to obtain a traffic information message and the traffic information message is then decoded (S983). The process of demodulating the received signal may vary depending on the signal communication system.

Identification information corresponding to at least one of a plurality of location reference methods for representing location information used to provide traffic information is obtained from the traffic information message (S985).

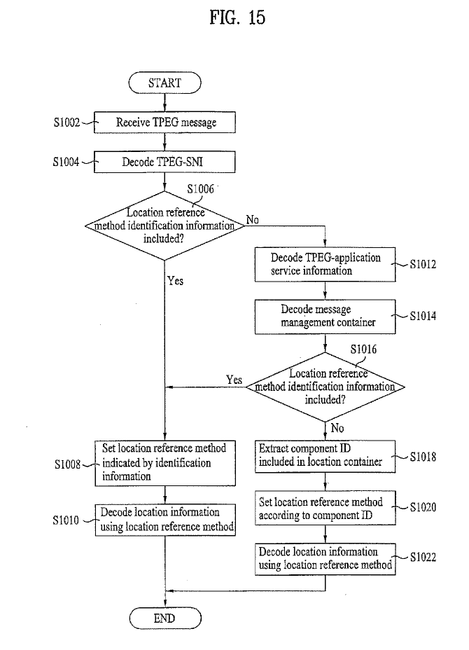

Location information of a location reference method corresponding to the identification information obtained at step S985 is decoded to provide traffic information (S987). A detailed example of the process of decoding the location information of the location reference method corresponding to the identification information obtained at step S985 is described below with reference to FIG. 15.

FIG. 15 is a flow chart of a method for decoding location information using identification information according to an embodiment.

First, a TPEG message is received (S1002). Here, the TPEG message is received in the form of a data stream.

TPEG-SNI included in the TPEG message is decoded (S1004). Since TPEG-SNI is included in a TPEG message whose SCID value is “00” as illustrated above, the TPEG-SNI of the TPEG message can be obtained by performing SCID value decoding and extracting information whose SCID value is “00”. The obtained TPEG-SNI is then decoded.

It is then determined whether or not identification information of a location reference method is included in the decoded TPEG-SNI (S1006). Location reference method identification information may also be included in TPEG-SNI depending on the table format as illustrated in FIG. 6.

If it is determined at step S1006 that location reference method identification information is included in the TPEG-SNI, it is possible to obtain a location reference method indicated by the identification information included in the TPEG-SNI (S1008).

Location information included in the TPEG message is decoded using the obtained location reference method (S1010).

On the other hand, if it is determined at step S1006 that location reference method identification information is not included in the TPEG-SNI, TPEG-application service information is decoded (S1012). Here, the TPEG-application service information may include Congestion and Travel Time (CTT) information, a Road Traffic Message (RTM), or Public Transport Information (PTI).

A message management container included in the TPEG-application service information is then decoded (S1014). The message management container includes information elements used to manage a message. For example, the message management container may include a message ID, version information, message generation information, etc. The message management container may also include identification information indicating a location reference method as illustrated in the second embodiment.

It is then determined whether or not identification information indicating a location reference method is included in the message management container (S1016). The identification information may be recorded in one of the fields included in the message management container as illustrated in FIG. 8.

If it is determined at step S1016 that the identification information is included in the message management container, a location reference method indicated by the identification information is obtained (S1008) and location information is decoded according to the obtained location reference method (S1010).

On the other hand, if it is determined at step S1016 that no identification information indicating a location reference method is included in the message management container, a component ID including a location reference method is extracted from a location container (S1018).

A location reference method is obtained according to the extracted component ID (S1020) and location information included in a container according to the ID included in the location container is then decoded (S1022).

The example of FIG. 15 is illustrated for the case where location information according to a location reference method has been set according to all the embodiments illustrated above. The example of FIG. 15 can also be easily applied when location information according to a location reference method has been set according to one or more of the embodiments illustrated above.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for transmitting traffic information, the method comprising:
encoding a traffic information message including an identifier of at least one of a plurality of location reference methods for representing location information used to provide traffic information; and
transmitting the encoded traffic information message.

2. The method according to claim 1, wherein the identifier of the location reference method is included in Service and Network Information (SNI) that is guide information of a service provided by the traffic information message.

3. The method according to claim 1, wherein the identifier of the location reference method is included in a message management container of the traffic information message.

4. The method according to claim 1, wherein the identifier of the location reference method is included in a component identifier included in a location container in the traffic information message.

5. The method according to claim 1, wherein the plurality of location reference methods includes at least one of a TPEG-LOC method, a pre-coded Korean node-link ID method, an Agora-C method, and a VICS link method.

6. The method according to claim 1, wherein the location reference method is a pre-coded method or a dynamic method.

7. The method according to claim 1, wherein the traffic information message includes a message management container, an application container, and a location container.

8. A method for receiving traffic information, the method comprising:
receiving a signal including a traffic information message;
demodulating the received signal to obtain a traffic information message and decoding the traffic information message;
obtaining, from the traffic information message, an identifier of at least one of a plurality of location reference methods for representing location information used to provide traffic information; and
providing traffic information according to location information based on the location reference method.

9. The method according to claim 8, wherein the identifier of the location reference method is included in Service and Network Information (SNI) that is guide information of a service provided by the traffic information message.

10. The method according to claim 8, wherein the identifier of the location reference method is included in a message management container of the traffic information message.

11. The method according to claim 8, wherein the identifier of the location reference method is included in a component identifier included in a location container in the traffic information message.

12. The method according to claim 8, wherein the plurality of location reference methods includes at least one of a TPEG-LOC method, a pre-coded Korean node-link ID method, an Agora-C method, and a VICS link method.

13. The method according to claim 8, wherein the location reference method is a pre-coded method or a dynamic method.

14. The method according to claim 8, wherein the traffic information message includes a message management container, an application container, and a location container.

15. An apparatus for receiving traffic information, the apparatus comprising:
a wireless communication unit for receiving a signal including a traffic information message;
a demodulator for demodulating and outputting a signal output by the wireless communication unit;
a decoder for decoding a traffic information message from a signal output by the demodulator;
a storage unit for storing geographical information according to location information that can be used to present traffic information;
a GPS module for outputting current location information;
a controller for obtaining an identifier of at least one location reference method output by the decoder and performing a control operation to present traffic information of the traffic information message according to location information of a location reference method corresponding to the identifier using both the geographical information stored in the storage unit and the current location information output by the GPS module;
a display driver for outputting a drive signal to present a graphic signal according to control of the controller; and
a display for presenting traffic information according to the drive signal from the driver.

16. The apparatus according to claim 15, wherein the identifier of the location reference method is included in Service and Network Information (SNI) that is guide information of a service provided by the traffic information message.

17. The apparatus according to claim 15, wherein the identifier of the location reference method is included in a message management container of the traffic information message.

18. The apparatus according to claim 15, wherein the identifier of the location reference method is included in a component identifier included in a location container in the traffic information message.

19. The apparatus according to claim 15, wherein the plurality of location reference methods includes at least one of a TPEG-LOC method, a pre-coded Korean node-link ID method, an Agora-C method, and a VICS link method.

20. The apparatus according to claim 15, wherein the location reference method is a pre-coded method or a dynamic method.
